(19) United States
(12) Patent Application Publication
(10) Pub. No.: US 2008/0147360 A1
(43) Pub. Date: Jun. 19, 2008

(54) System and method for simulating the time-dependent behaviour of atomic and/or molecular systems subject to static or dynamic fields

(76) Inventors: Anthony Peter Fejes, Vancouver (CA); John Silvio Vieceli, Vancouver (CA); Shayan Rahnama, Toronto (CA); Ganesan Swaminathan, Surrey (CA)

Correspondence Address: Ralph A. Dowell of DOWELL & DOWELL P.C., 2111 Eisenhower Ave, Suite 406, Alexandria, VA, 22314, US

(21) Appl. No.: 11/581,075

(22) Filed: Oct. 16, 2006

(51) Int. Cl. G06F 17/10

(52) U.S. Cl. 703/2

(57) ABSTRACT

A method and system are disclosed for simulating the behavior of atomic and molecular scale systems. The method makes use of two (or more) embedded or mixed molecular systems, or collections of particles, that interact with each other through a mediated process, allowing the effects of the forces from one collection of particles to act on the particles in the other. The system includes a series of modules, two of which contain the simulation techniques to be used on the collections particles, one of which is to mediate between the collections, for example one module may be used to evaluate positional and/or energetic information, and one may be included to wrap around the entire molecular system to drive all of the events. The method generates representations of the molecular system that allow the user to gain an understanding of the system being simulated. The method may be applied to any molecular simulation involving more than one molecule, or any (molecular or non-molecular) system in which the simulated objects exhibit behaviors of interest that manifest on different timescales, in systems where enhanced conformational space sampling is required or in any system where the specific trajectory of some molecules is not of interest.

### FIELD OF THE INVENTION

The present invention relates to the field of computer-based simulations of atoms and molecules, useful for designing enzymes for various industrial applications, and in particular for the study of solvent/solute systems or heterogeneous systems, where different particles of the system are treated using different simulation techniques and their interactions are included using a grid storage and retrieval strategy. This process may also be applied to homogeneous systems, although a decision is made by the user to decide which particles are treated by the different simulation techniques.

### BACKGROUND OF THE INVENTION

One particular problem that fits into this class of system is in the simulation of proteins in solution. For large systems using conventional simulation techniques, i.e., Molecular Dynamics (MD) simulations, sufficient sampling of conformational states requires simulation times that range from tens to thousands of nanoseconds, and can require a significant amount of computer processing power to achieve sufficiently long runs. The term MD simulation refers to the class of algorithms where the motion of particles is propagated in time using forces derived from either empirical¹, semi-empirical², ab initio³, or coarse-grained⁴ potentials. This can include classical Molecular Dynamics, as well as dynamics propagated through Quantum Mechanics (QM), such as Car-Parrinello molecular dynamics⁵ and QM/MM (Molecular Mechanics) methods.⁶ (All references to MD can also be understood to include QM.)

It is undisputed that increasing the speed of simulations, or sampling more conformational states in a simulation while requiring less computational time would be of significant value to any industry that currently uses molecular simulations. Examples can be found throughout the literature of ways in which faster molecular simulations have been sought after. Inherent in the modeling process is the selection of how much detail to include in the model. In computational modeling, a trade off always exists between accuracy of the model and the speed at which the model can be simulated. Thus, for faster simulations, model builders often make approximations. Some of these approximations have included fixing the lengths or angles of bonds⁷, combining multiple bodies into single bodies⁸, or removing bodies entirely from the simulation^{9,10}. Each of these approximations comes at a cost of the accuracy of the simulated system. The “holy grail” of simulations is to find a method that allows the rapid speed of simulation to be achieved without sacrificing the level of detail required for high accuracy results.

The value of high-accuracy simulations can be seen throughout a number of fields and applications. They are found at all levels of physics from astrophysics¹¹, as well as in materials design and engineering¹², and biochemistry¹³. Of particular interest is the simulation of biological systems, where the complexity of the problems is such that simulations are frequently the only way to capture any form of understanding of the sequence of events in atomic level detail.

In order to gain a better understanding of molecular systems, a number of academic computer molecular simulation software programs driven simulation packages have been created. At the current time, some of the best known are (http://amber.scripps.edu/) AMBER¹⁴, (http://www.charmm.org/) CHARMM¹⁵, (http://www.ks.uiuc.edu/Researchlnamd/) NAMD¹⁶, (http://www.gromacs.org/) GROMOS/GROMACS^{17,18}. All of these packages are capable of performing various types of molecular dynamics simulations. Specifically, these packages are capable of performing simulations with “explicit” solvents, where an atomic representation of each solvent molecule is included in the molecular dynamics simulation and is moved accordingly, at significant computational cost. Many of them are also able to perform simulations with “implicit” solvents, where the atomic representation of the solvent molecules is replaced by a general force used to simulate the collective effects of the now removed solvents on the remaining molecules^{19,20}. The implicit solvent approximation reduces the execution time of the simulation relative to explicit solvent simulations by several orders of magnitude, however, it has been demonstrated that the simulation accuracy is significantly compromised^{21,22}. To overcome the shortcomings of implicit solvent simulations, numerous techniques have been devised where hybrids of these techniques can be used, which include solvent caps²³ and distance dependent techniques²⁴.

### DESCRIPTION OF RELATED ART

The current state of the art of molecular modeling technique is represented by the following public domain publications.

L. J. LaBerge and J. C. Tully, A rigorous procedure for combining molecular dynamics and Monte Carlo simulation algorithms, Chemical Physics 260:183-191 (2000). Briefly, this publication discloses a method in which molecules in a single simulation system can be moved by either MC or MD. They demonstrate that allowing each molecule to move in either MC or in MD, but not both, can give rise to a valid Markov chain in configuration space. They postulate that the efficiency of their method depends on the computational cost of calculating forces, though no attempt to reduce the number of force calculations is undertaken.

X-W Wu and S-S Sung, Simulation of Peptide Folding with Explicit Water—A Mean Solvated Method, Proteins: Structure Function and Genetics 34:295-302 (1999). Briefly, this publication discloses a method where solvent molecules of a simulation can be simulated separately from the solute molecules, through different methods. They demonstrate that by using Monte Carlo to simulate the motion of a solvent molecule, and Molecular Dynamics to simulate a solute molecule, it is possible to obtain very good sampling of the solute conformational states. Using their method, there is no attempt to modify or alter the mechanism of interaction between the solvent and solute molecules. Solvent molecules are moved around the frozen solute, and for each MD simulation step, two attempts to move every solvent particle are made using a force-biased MC method. This technique provides no inherent improvement in speed, although a performance gain was observed by integrating a “rigid fragment” approach into their simulation method.

F Guarnieri and W. C. Still, “A Rapidly Convergent Simulation Method: Mixed Monte Carlo/Stochastic Dynamics, Journal of Computational Chemistry 15(11): 1302-1310 (1994). Briefly, this publication discusses a method in which a system containing a single solute molecule is simulated by alternating between Stochastic Dynamics and Metropolis Monte Carlo. This method shows that the sampling of configuration space of the solute is greatly improved over standard Stochastic Dynamics, and that the converged simulation results could be obtained using less CPU time.

S. Duane, A. D. Kennedy, B. J. Pendleton and D. Roweth, Hybrid Monte Carlo, Physics Letters B 195(2):216-222 (1987). Briefly, this publication discloses a method of alternating between Monte Carlo and a Molecular Dynamics method in the simulation of fermions for the purpose of reducing approximation errors inherent in the use of either method alone.

Chiu S W, Jakobsson E, Subramaniam S, Scott H L. Combined Monte Carlo and Molecular Dynamics Simulation of Fully Hydrated Dioleyl and Palmitoyl-oleyl Phosphatidylcholine Lipid Bilayers, Biophys J, November 1999, p. 2462-2469, Vol. 77, No. 5; and Chiu S W, Jakobsson E, Scott H L, Combined Monte Carlo and Molecular Dynamics Simulation of Hydrated Lipid-cholesterol Lipid Bilayers at Low Cholesterol Concentration, Biophys J, March 2001, p. 1104-1114, Vol 80; are publications that disclose a method in which Molecular Dynamics simulations are performed, interrupted by sequences of configurational bias Monte Carlo in which moves are attempted on a subset of the molecules in the simulated system.

### SUMMARY OF THE INVENTION

A computer-based system is disclosed that is capable of simulating trajectories of molecular systems given the starting conformation. This functionality allows the user of the invention to gain insight into systems of interest, and to develop hypotheses around the possible effects of the interactions of the components of the system. With one embodiment of the invention described, a method of combining Monte Carlo (MC) and Molecular Dynamics (MD) simulations, it is possible to simulate the behavior of molecules while enhancing the sampling of conformational states, to provide greater insight into the interaction of the molecules with their environment at a rapid speed. The accuracy of the simulation is comparable to that of an explicit solvent simulation, while the execution time is intermediate between explicit and implicit solvent simulations.

This invention is a very broadly applicable technology that can be used in a wide variety of modeling applications, and in each application, we can obtain different “chemical” information. Examples of the various modeling applications are given, where the method in brackets describes the simulation system used for each set of particles. The two preferred simulation techniques used in the present method include Monte Carlo simulations (MC) and molecular dynamics simulations (MD). These examples include modeling one or more solutes (MD) in solvent (MC), modeling a protein (MD) embedded in a membrane (either MC or MD) surrounded by solvent (MC), or modeling a protein (MD) and a ligand (either MC or MD) in solvent (MC). The method disclosed herein could also be used in other places, such as the simulation of mesh systems (implicit or explicit integration) for the behaviour and rendering of cloths for animations, or simulating the paths of particles in fluid dynamics applications.

Undoubtedly there are many other techniques where forces are being calculated repeatedly that may not be necessarily changing at a timescale of interest. Fundamentally, this system allows us to investigate systems where the timescale of one or more behaviours in a single system is different, or where the level of detail required in a simulation is different for different parts (i.e. proteins have behaviours that manifest over picoseconds to nanoseconds, where water molecules have networks that only exist at the tens of femtoseconds scale). This technique, used to calculate forces on particles, has been termed the Potential of Net Force (PNF) method.

The user of the invention can also specify the conditions in which the simulation takes place. These conditions can include, but are not limited to, the temperature of the simulation, the number of molecules to be simulated, the volume occupied by the simulated molecules, the length of time represented by each simulation step, the number of simulation steps to be taken, and any other information that may be required or desirable to control in the simulation.

By using the method disclosed herein, the determination of the properties of complex systems, particularly enzymes and biologically derived systems, can be studied rapidly and with a high level of accuracy. In contrast to traditional molecular dynamics simulations that completely explore accessible configuration space given sufficient time, using this device and method provides improved conformational sampling by adjusting the solvent via Monte Carlo rather than propagating their motion through MD. When combined with the stochastic nature of the forces exerted on the MD molecules by the MC molecules through this device and method, molecules of interest are better able to surmount barriers between configurational states more frequently. Therefore, a greater amount of detailed information can be accumulated using a reduced amount of computational time, saving resources and enhancing the understanding of complex systems. In one aspect of the invention there is provided a method for simulating the behavior of a system formed by a plurality of particles using at least two different simulation techniques, comprising the steps of:

a) forming a first collection of particles from some of said plurality of particles, and forming at least a second collection of particles from a remainder of said plurality of particles;

b) simulating behavior of the particles in said first collection of particles using a first simulation technique;

c) repeating step b) a first pre-selected number of times;

d) obtaining and storing information about said particles in said first collection of particles, characteristic of said first simulation technique, from steps and b) and c); e) simulating behavior of the particles in said second collection of particles using at least a second simulation technique using said information obtained and stored in step d);

f) repeating step e) a second pre-selected number of times; and

g) repeating steps b) to f) inclusive a user determined number of times until the user has observed a time evolution of the system from which useful information can be extracted.

In another aspect of the invention there is provided a system formed by a plurality of particles using at least two different simulation techniques, the system comprising:

a computer processor having computer storage, the computer processor being programmed for the tasks of

i) forming a first collection of particles from some of said plurality of particles, and forming at least a second collection of particles from a remainder of said plurality of particles;

ii) simulating behavior of the particles in said first collection of particles using a first simulation technique;

iii) repeating task ii) a first pre-selected number of times;

iv) obtaining and storing information about said particles in said first collection of particles, characteristic of said first simulation technique, from the results of tasks ii) and iii);

v) simulating behavior of the particles in said second collection of particles using at least a second simulation technique using said information obtained and stored during task iv);

vi) repeating task v) a second pre-selected number of times; and

vii) repeating tasks ii) to vi) inclusive a user determined number of times until the user has observed a time evolution of the system from which useful information can be extracted.

A further understanding of the functional and advantageous aspects of the invention can be realized by reference to the following detailed description and drawings.

### BRIEF DESCRIPTION OF THE DRAWINGS

The invention will be more fully understood from the following detailed description taken in connection with the accompanying drawings, which form a part of this application, and in which:

FIG. 1 is a block diagram of the system of the present invention;

FIG. 2 is an example simulation system in which a single molecule of dichloroethane, shown in ball and stick representation, is surrounded by a lattice of water molecules, shown as V-shaped molecules;

FIG. 3 is a diagram of the modules present in a MC/MD simulation, employed by the system in FIG. 1;

FIGS. 4A-4E are illustrations of the steps required in the initialization process for simulating a molecule using a solvated box of water;

FIGS. 5A-5F represent the various stages of a simulation using the PNF module, employed by the modules in FIG. 3;

FIG. 6 is a flow chart representing a method employed by the Event Step module in FIG. 3;

FIG. 7A is a diagrammatic representation of the forces in the simulation during the Force-Bias Monte Carlo Step;

FIG. 7B is a diagrammatic representation of the forces in the simulation during the Molecular Dynamics with Potential Net Force for a molecule simulated using Molecular Dynamics;

FIG. 8 is a diagrammatic illustration of a cubic grid employed around each atom in the PNF method;

FIG. 9 is a diagrammatic illustration of a particle traveling through a two-dimensional PNF grid;

FIG. 10 is a diagrammatic illustration of the distances to solvent particles (simulated by Monte Carlo) from particular atoms in solute molecules (simulated by Molecular Dynamics) for large solutes; and

FIG. 11 is a block diagram (flow chart) showing a method employed by the PNF module in FIG. 3.

### DETAILED DESCRIPTION OF THE INVENTION

### DEFINITIONS

As used herein, the term “ensemble” refers to the set of macroscopic conditions that are held constant during the course of a simulation, typically referring to the number of atoms (N), the chemical potential (p), the average temperature (T), the pressure (P), the volume of the simulation space (V), the enthalpy of the system (H), and the energy of the system (E). Common ensembles include pVT, NVT, NVE, NPT, NPH.

As used herein, the phrase “molecular dynamics (MD) simulations” refers to deterministic computer simulations that are used to calculate the trajectory of the particles.

As used herein, the phrase “Monte Carlo (MC) simulations” refers to stochastic or non-deterministic simulations used to sample conformational states and obtain equilibrium properties of a system.

As used herein, the term “particles” refers primarily to atoms or molecules, but can also be applied to any other body, including elements of cloth in a mesh, solid bodies, elements of a liquid, or other macroscopic bodies.

As used herein, the phrase Quantum Mechanics (QM) or Quantum Mechanical Simulations refer to the use of quantum derived methods of propagating motion of atoms, as well as the calculation of atomic properties at a higher level than would be possible using classical or Newtonian equations of motion. This term broadly covers all forms of quantum simulations, including but not limited to Carr-Parinello simulations, Ab initio simulations, DFT calculations and semi-empirical calculations.

As used herein, the term “collection” refers to the set of particles assigned to one of the simulation techniques used. One collection is created for each simulation technique applied, and sub-sets of each collection may be created in order to simulate some molecules with higher level resolution than other atoms within the collection.

As used herein, the terms “comprises”, “comprising”, “including” and “includes” are to be construed as being inclusive and open-ended. Specifically, when used in this document, the terms “comprises”, “comprising”, “including”, “includes” and variations thereof, mean the specified features, steps or components are included in the described invention. These terms are not to be interpreted to exclude the presence of other features, steps, or components.

The present invention provides a method for simulating the behavior of atomic and molecular scale systems. The method makes use of two mixed molecular systems that interact with each other through a mediated process, allowing the effects of the forces from one collection of particles to act on the particles in the other collection. The method may be applied to any molecular simulation involving more than one molecule, or any (molecular or non-molecular) system in which the simulated objects exhibit behaviors of interest that occur on different timescales, in systems where enhanced conformational space sampling is required or in any system where the specific trajectory of some molecules is not of interest. Particular use of this invention may be found at the atomic and molecular levels, where solvent molecules interact with solute molecules.

Particularly, the present invention provides a method for transferring information from molecules simulated using one simulation technique to molecules simulated using another simulation technique. The method disclosed herein may be used in a wide variety of applications. In each of these cases, the method will yield different chemical or physical information. Fundamentally, the method is useful when looking at applications where time-dependent behaviours manifest on different scales for molecules, or where the level of detail required in a simulation across parts of the system is not identical. For example, proteins have behaviours that manifest over time periods of picoseconds to nanoseconds, where water molecules have hydrogen bonding networks that manifest on the femtosecond time scale.

Further examples include the modeling of a solute in an aqueous solvent where the solute molecules are modeled using MD techniques and the solvent molecules are modeled using MC techniques in order to observe the trajectory of the solute molecules, while obtaining the effects of the solvent. A subset of the atoms or molecules allocated to the MD portion of the system may be modeled or simulated using higher resolution molecular dynamics techniques to give greater detail, while lower-resolution techniques may be applied to the remaining MD particles. Complex systems involving a variety of molecular components may also be modeled in this manner.

The method for simulating the behavior of a system formed by atoms or molecules using at least two different simulation techniques includes assigning some of the atoms or molecules to one collection which is to be simulated using the first of the two different simulation techniques and assigning the remaining atoms or molecules to the second collection to be modeled using the second simulation technique. The behavior of the atoms or molecules assigned to the first collection are then simulated using the first simulation technique. The behavior of the second collection of atoms or molecules are then simulated using the second simulation technique while using the stored information obtained from the first simulation technique. The stored information from the first simulation technique can be used for as long as deemed necessary by the user of the system. The user may determine what amount of sampling is appropriate for the system being simulated, and can adjust the frequency with which the simulation will update the positions of the atoms and particles in the collection simulated by the first simulation method. Thus, in the case where the second simulation technique is molecular dynamics, the length of time for which the second simulation can be run will be determined by the sampling of forces required by the user.

This process is repeated, namely the first simulation is repeated and the second simulation repeated using the new information obtained and stored from the repeated first simulation a user determined number of times until the user has observed a time evolution of the system from which useful information can be extracted. The termination conditions for a simulation are ultimately dependent upon the goals of the modeling experiment, whether it is energy minimization, generation of a stable configuration, passing of a given amount of simulated time, observation of changes to the conformational properties of biomolecules, or any other purpose to which a simulation can be applied.

The process of switching between the first and second simulation techniques can then be repeated a user determined number of times to observe the behavior of the system in question, and particles or molecules may be re-allocated between simulation techniques. In other words the simulation of the atoms or molecules assigned to the first simulation technique is repeated as many times as deemed useful, and the results stored, after which the atoms or molecules assigned to the second simulation technique are modeled using the stored results of the first simulation, and atoms or molecules may be subsequently reassigned to one or the other simulation technique.

The combinations of simulation techniques may include any combination of Monte Carlo simulations, molecular dynamics, and may employ any of the variety of simulations that may fit those descriptions. Monte Carlo simulations are used for situations in which the general behaviour of the particles is required, but their absolute path is not of interest. This is particularly visible in Monte Carlo simulations in which sampling configurational or conformational space is the goal, but the transitions between the states in that space is not of interest, or in which the goal of a simulation is to quickly converge towards some property of interest by sampling sufficiently through various states.

Molecular dynamics simulations are used for situations in which the trajectory of the particles in the simulation are of interest. The information provided by modeling a system using molecular dynamics may include the trajectory of any one or all of the molecules in the collection.

When performing the simulations, all the simulations are run in the same ensemble. For example, if the molecular dynamics simulation is run in the NPT ensemble (constant number of atoms, constant pressure, constant temperature), then the Monte Carlo is also run in the NPT ensemble. This also applies to other ensembles such as NVT (constant number of molecules, constant volume, constant temperature). Running for example the molecular dynamics simulation in one ensemble and the Monte Carlo simulation in another ensemble would yield results that would be impossible to interpret in the context of any relevant laboratory experiment. Similarly, if a higher resolution molecular dynamics simulation is being performed on a subset of the collection of particles undergoing the molecular dynamics simulation, they are also run in the same ensemble as the rest of the particles simulated in the molecular dynamics simulation and the collection of particles in the Monte Carlo simulation.

In one embodiment of the method, the collection that a molecule belongs to may be switched during the course of the iterations through the process. This is useful if the time-dependent trajectory of a molecule in the molecular dynamics simulation is no longer of interest and should be treated via Monte Carlo or if the time-dependent trajectory of a molecule in the Monte Carlo simulation is of interest and should be treated via molecular dynamics. For example, the user may be interested in the time-dependent trajectories of molecules within a certain distance from one of the molecules in the molecular dynamics collection. As molecules diffuse through the system, they may be switched between the Monte Carlo and molecular dynamics collections depending on the distance from the molecule of interest in the molecular dynamics collection. Thus the method may include reassigning some or all particles in the first collection to the second collection, or reassigning some or all particles in the first collection to the second collection and reassigning some or all the particles in the second collection to the first collection, or reassigning some or all the particles in the second collection to the first collection.

In a particular embodiment of the method, the step of obtaining information characteristic of the first simulation technique may include calculating forces exerted by the atoms, or atoms making up the molecules, assigned to the Monte Carlo simulation, and storing these forces at a pre-selected number of grid points surrounding each atom, or atoms making up the molecules, assigned to the molecular dynamics simulation. The step of simulating the behavior of the atoms or molecules assigned to a second simulation technique may include interpolating from the grid to obtain a force experienced by each atom, or each atom making up the molecules, in the molecular dynamics simulation to obtain a net force at the atoms current position.

The pre-selected number of grid points may be evenly spaced in a geometric pattern around each atom or the atoms making up the molecule. Alternatively, the pre-selected number of grid points may be unevenly spaced in a geometric pattern around each atom, or atoms making up the molecule. The unevenly spaced grid points are positioned around each atom, or atoms making up the molecule, in response to a predicted path of the atom, or atoms making up the molecule. The interpolation may be performed by any one of several interpolation techniques, including linear interpolation, polynomial interpolation, spline interpolation and any combination thereof.

With respect to the Monte Carlo simulation, the method may use any form of Monte Carlo simulation, which can include Metropolis MC, Force Biased MC, Smart MC or other types. Any Monte Carlo technique may be used interchangeably, although the Force Biased Monte Carlo has been observed to converge more quickly in simulations containing molecular dynamics simulated particles. The force-biased Monte Carlo simulation differs from the Metropolis Monte Carlo method in that the moves attempted are biased in the direction of the force exerted on the particle, and is used when the particles experience a net force from neighboring objects.

When starting, the system preferably is first equilibrated. This process is performed to bring the system into a position where the forces exerted between particles can be handled stably by the computational device used to propagate motion of the particles. This is often done by performing energy minimizations on the structure, or by performing Monte Carlo simulations, where the energy is guided towards a Boltzmann distribution for a given temperature.

It will also be understood that in the case where two simulations are being performed, the first and second simulation techniques may be both the same type of simulation but using different methods of propagating motion. One example of this method is to use a quantum mechanical derived molecular dynamics simulation and a classically derived molecular dynamics simulation.

The present method may use more than two simulation techniques. In the examples below, Monte Carlo techniques are used to simulate the behavior of one collection of atoms or molecules and molecular dynamics are used to simulate the behavior of the rest of the atoms or molecules in the other collection. However, it will be understood that a fraction of the atoms or molecules may be allocated to a third collection and simulated using a third simulation technique. The order in which these simulations are carried out, the number of times they are repeated will all depend on the application at hand. Alternatively, quantum mechanical simulations may be carried out on all or a subset of the collection of particles assigned to the molecular dynamics simulation as a high resolution version of the molecular dynamics simulation.

In addition, while the invention is directed primarily at molecular systems as discussed in more detail below, it will be understood that the present invention is applicable to macroscopic systems. This technique could be applied to other systems in which forces between particles exist, and could be updated at a lower frequency. One example would be in the case of rendering the behaviour of cloth, in which each element of a two-dimensional lattice pulls on its neighbors and experiences additional external forces.

The method may be implemented using a series of programmed modules, two of which contain the methods for the available simulation techniques, one module to mediate between the simulation technique modules, a further module may be used to evaluate positional and/or energetic information, and another module may be included to wrap around the entire molecular system to drive all of the events. Further modules may be included to perform other functions in the various embodiments of the device, and the modules above may be combined or further divided at will. The device generates representations of the molecular system which allow the user to gain an understanding of the system being simulated.

The present invention will now be exemplified by the following non-limiting example.

### EXAMPLE

### MC and MD Modeling

### Overview

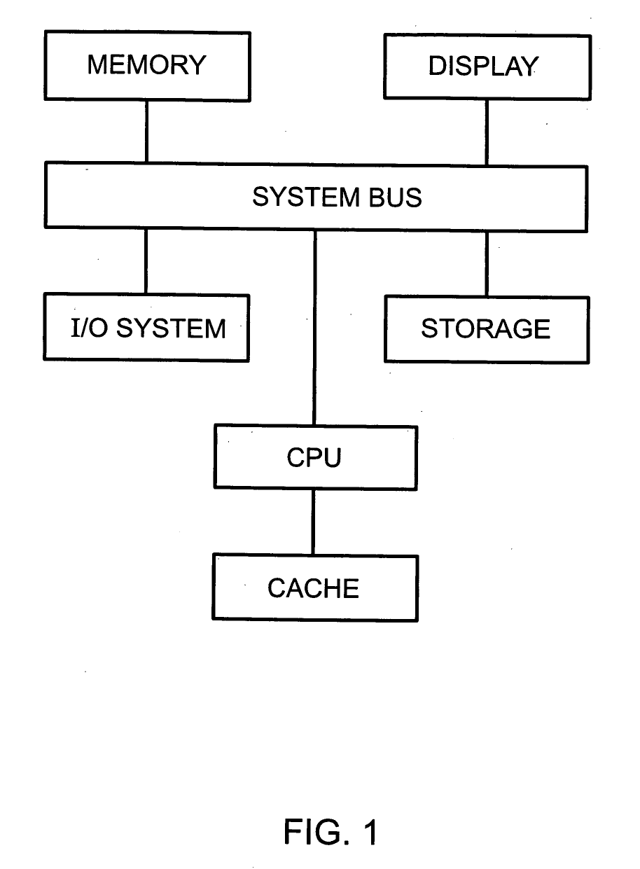

This section describes a specific embodiment of the method of hybrid Monte Carlo/Molecular Dynamics molecular modeling, using a Potential of Net Force module to transfer forces from the collection of particles in the portion of the system of lesser interest to the collection of particles in the remaining portion of the system of greater interest. The operations embodied in this method could be performed on a computer system of the type shown in FIG. 1. The computer system comprises an input means such as a keyboard for specifying (entering) system data or simulation parameters, a RAM (random access memory) for storing such data, a ROM (read only memory) for storing programs, a display unit or printer for providing feedback, storage media for storage of programs and data relevant to simulations, and at least one processor for simulating, under the control of the stored program, the interactions of the elements included in the simulated system. The interaction between these elements is illustrated in FIG. 1.

A hybrid MC/MD program is employed to simulate systems provided by the user of the invention. The system specified by the user is separated into two collections of particles, those that are most appropriately simulated by MC, where the time-dependent bahaviour of the molecules is not of interest, and those that are most appropriately simulated by MD, where the time-dependent behavior of the molecule(s) is desired. In the case of simulating systems involving some sort of solute in a solvent, the method will generally be expected to assign the solvent into one collection to be simulated by MC, (i.e. water in the case of an aqueous solvent) and the solute into another collection to be simulated by MD, where everything that is not specifically water is included, or a variation upon this division. While not limited to the following, the solute may be composed of small molecules, DNA, proteins or other biological or organic-based molecules, or inorganic molecules.

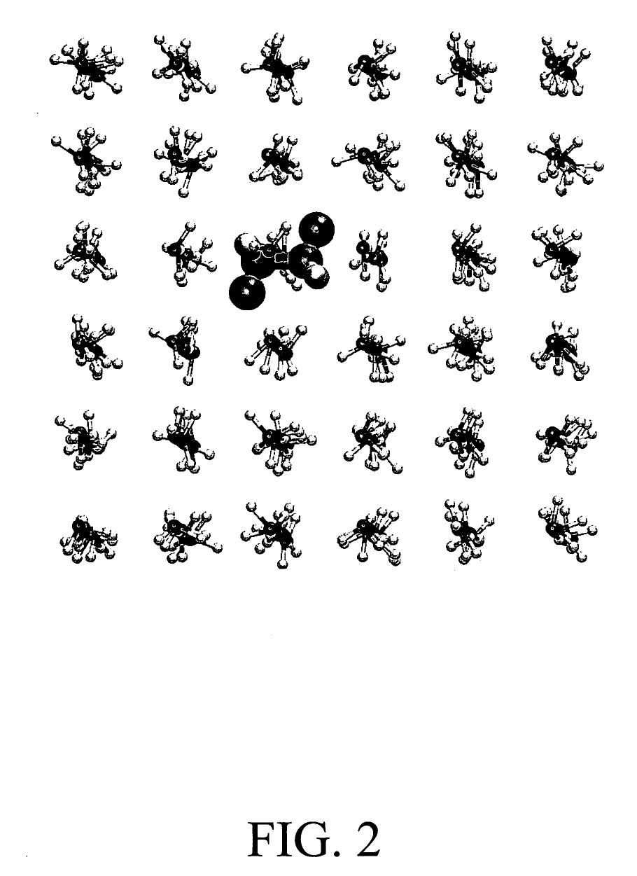

An example simulation system is given in FIG. 2 in which a single molecule of dichloroethane is surrounded by a lattice of water molecules. The dichloroethane is shown in ball and stick representation in the centre of the system while the waters are shown as V-shaped molecules. In one possible simulation, the dichloroethane would be simulated by molecular dynamics, while the water molecules would be simulated using Monte Carlo methods. The cubic three-dimensional system, with a 7 by 7 by 7 lattice of water molecules, is shown in a projection such that each visible water molecule is hiding 6 water molecules behind it.

As part of the simulation conditions when modeling a solute in a solvent using MD and MC simulations, a force field is also required, which includes information about the interaction of all particles in the simulation. The method applies the information in the force field to the particles provided in the simulation space provided by the user, and utilizes the parameters specified by the user to calculate the exact manner in which all particles in the simulation will interact. The first step is to calculate the forces on the collection of atoms and/or molecules assigned to the MD simulation due to the collection of atoms and/or molecules in the collection assigned to the MC simulation which are stored on a grid for each MD atom. The forces stored in the grid can then be interpolated for each MD atom at each step of the MD simulation. Thus, for the MD molecules, their intermolecular interactions with other MD molecules and intramolecular interactions are determined by performing a traditional MD simulation^{25,26}, while their interactions with MC molecules are obtained from the grid. The forces from the grid are interpolated based upon the instantaneous position of the MD atoms upon which the forces act. At some interval, the MC molecules are moved by means of a force-biased MC simulation^{27,28} and their forces upon the MD molecules are recalculated and stored in the PNF grid.

The method is thus used to generate data, which describes the time-dependent behavior of each MD particle in the simulation system. This information can be applied to the folding and unfolding pathways of proteins, to the docking and binding of multiple biomolecules, and the interactions of complex systems.

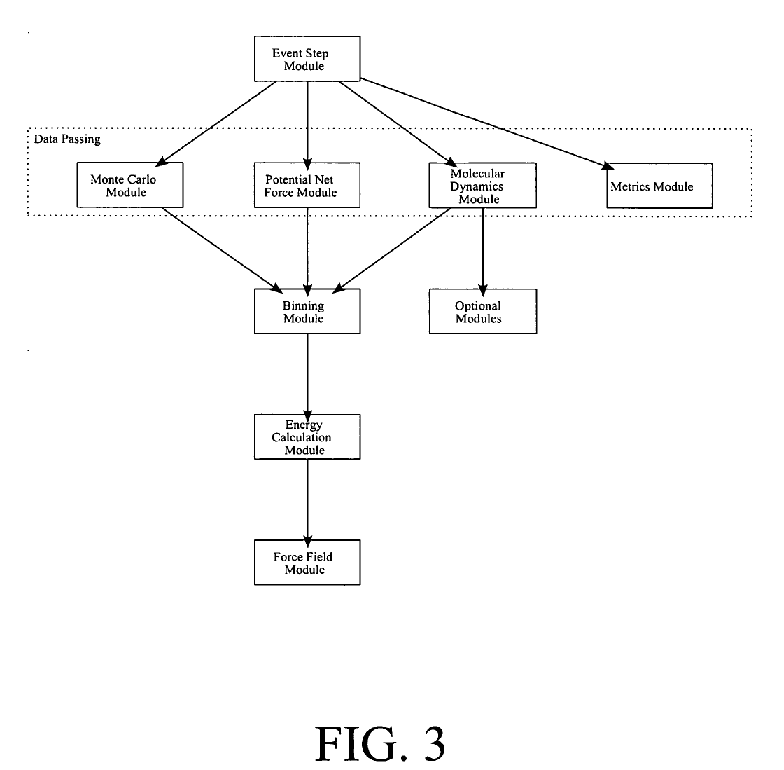

A simplified representation of the invention, as used for hybrid Monte Carlo/Molecular Dynamics simulations, is presented in FIG. 3, illustrating the main modules built into the device. The main module is the Event Step Module, which controls the procedures used by the device. The modules with which it communicates, are the Monte Carlo (MC) Module, the Potential Net Force (PNF) Module, the Molecular Dynamics (MD) Module and the Metrics Module. When a pure Monte Carlo simulation or a Molecular Dynamics simulation is used, the respective modules may be used independently. When the method of mixed simulations using the PNF method is employed, information is shared between these modules by two different methods. The Monte Carlo Module obtains information about the MD simulation molecules by looking at the data in the shared simulation space. In contrast, the Molecular Dynamics module obtains information through the use of the PNF module, which in turn obtains its information about the Monte Carlo portion of the simulation through the shared system. The Metrics Module is able to obtain information through any of the other modules in order to report on the various properties of the simulation system, such as atomic coordinates, energy, pressure, and temperature.

The Binning module provides an abstraction layer to the calculations performed to obtain system energies, through the use of the Energy Calculation Module and the Force Field module. The Binning module subdivides the simulation volume into smaller volumes, called bins. The particles located in each bin are stored. Since a cutoff distance is used when calculating the energy on each particle, beyond which the interaction energy is not calculated, bins are used to identify which particles are located at a distance less than the cutoff and should be included in the energy calculation.

The Energy Calculation Module determines the energy value for each interaction included in the simulation. The interactions that require an energy calculation in simulations of atoms and molecules are bond stretching, angle bending, proper and improper torsion, short-range Lennard-Jones, and long-range Coulombic. The calculation of each energy requires parameters depending on the types of atoms, e.g. carbon, nitrogen, oxygen, involved in the interaction. These parameters are supplied by the Force Field Module to the Energy Calculation Module. Thus, the three modules (Binning module, Force Field Module to the Energy Calculation Module) are used to calculate the energy and force for atoms within a collection and to generate the information that is stored by the PNF module and transferred between the two collections. These are inherent to Monte Carlo and MD simulations. Other modules may be added on to the MC or MD modules as required.

### Initializing the Simulation System

Initialization of a simulation system is a complex process that depends heavily on the nature of the system being initialized. For molecular simulations, it can span many steps, from the preparation of the model of the molecules of interest, all the way to the point at which the simulation is started. In one embodiment of the method the system of interest contains one or more solute molecules which will be surrounded by solvent molecules. The assumption is made that the solute(s) has been prepared, such that it includes all of the necessary information required to interface with a force field, has complete coordinates for atom positions, and any other specific information required by the simulation being performed. These conditions are typically performed independently of any simulation device. Once those above portions of the initialization process are complete, the setup can be performed for preparation of the simulation itself. This setup consists of five steps, which provide a guideline for beginning simulations with a system at equilibrium.

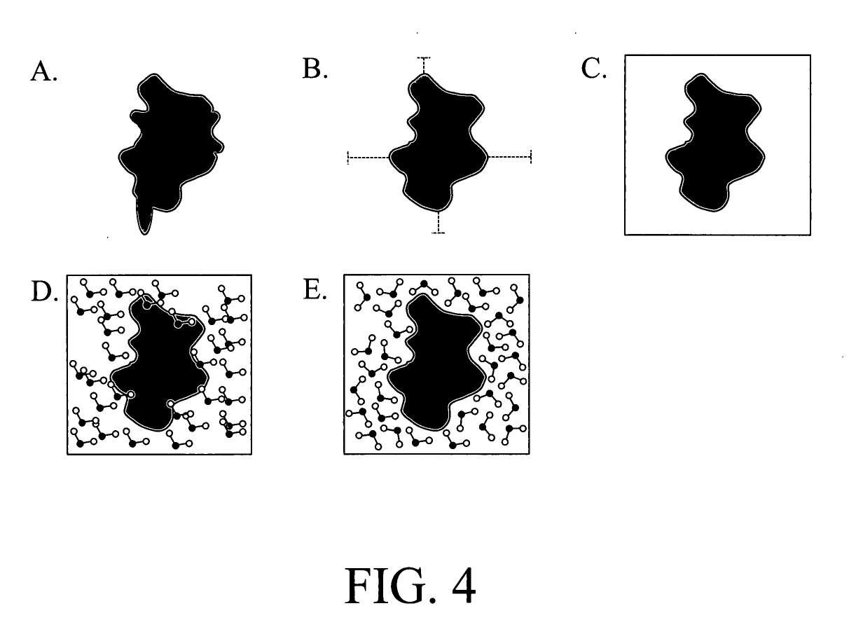

The first step is to perform a gas-phase equilibration of the solute molecule(s), represented in FIG. 4A by the shaded areas. This can be done by conjugate gradient, steepest descent, or any other appropriate minimization method. Discussion and descriptions of the goals of minimization and how to implement minimization algorithms can be found elsewhere²⁹.

The second step of this process is to set the system size, shown in FIG. 4B. For gas-phase simulations or for clusters, this step is not relevant as the system size is assumed to be infinite. However, for systems with periodic boundaries or hard boundaries, the positions of those boundaries are set in this step. Thorough discussions of this topic can be found elsewhere³⁰.

The third step is to centre the solute molecule within the boundaries, and to perform any adjustments that may be needed in setting the coordinate system, shown in FIG. 4C.

The fourth step is to fill the empty portions of the system with solvent molecules, shown in FIG. 4D.

The final step is to perform an equilibration process on the solvent, shown in FIG. 4E. This brings the system to the desired temperature, and removes any artifacts, such as lattice configurations, that may have been present due to the placement process.

### Event Loop Module

The event-loop module is the controlling portion of the device, which calls each of the other modules of the system, in turn. It uses user-provided inputs to determine which sub-modules to use, and how long each sub-module should be run in turn.

### Event Loop Initialization

Before the event loop can be run, the appropriate amount of computer memory is allocated to each module that will be called during the course of the simulation. Although this could be done “on-the-fly”, it is more efficient to perform memory allocation once before the event loop begins its function.

For each module requiring an initialization process, the appropriate initialization functions are called. This particularly applies to Molecular Dynamics Modules, Potential of Net Force Modules and Monte Carlo Modules. Explicit instructions on what is required for initialization of Molecular Dynamics and Monte Carlo Modules can be found elsewhere³¹.

For each optional module in the system, the event loop initialization sets the appropriate flags to identify those that will be used.

### Event Loop

The event loop itself calls each of the required modules in the device, in turn, and controls how long each is used. It coordinates the behaviour of the entire device, based upon the user provided parameters.

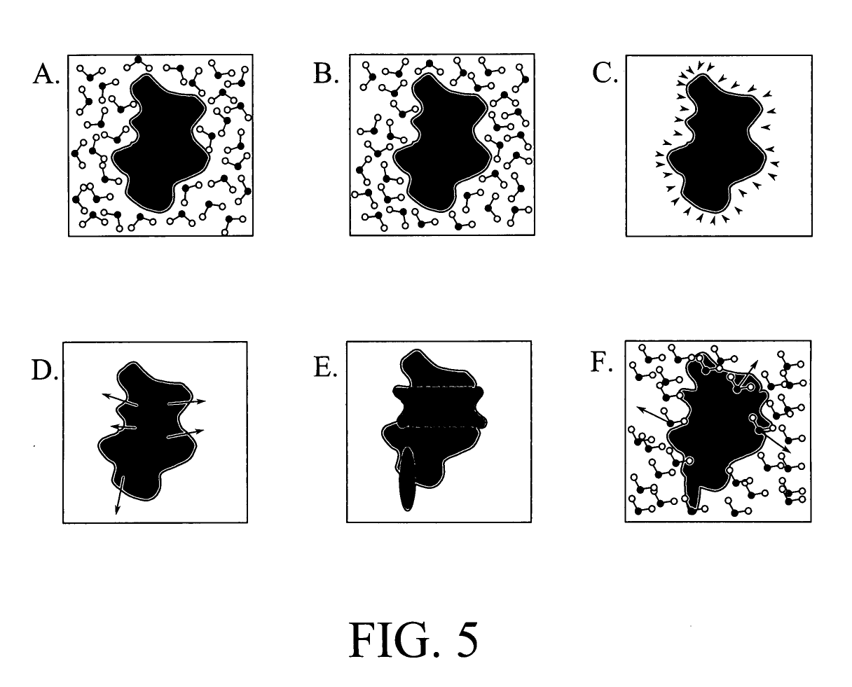

The key elements of the event loop module are illustrated in FIG. 5 for a MC and MD mixed simulation, in which the solvent molecules are assigned to the MC collection of particles, and the solute particles are assigned to the MD collection of particles. FIG. 5A shows the initial conformation of the system. From this starting point, one or more Force-Bias MC steps are undertaken on the solvent particles, for which the results are shown in FIG. 5B. The portion of the system that is simulated by MD is unaffected by this step. In FIG. 5C, the forces on the MD portion of the system due to the MC molecules are calculated, populating the PNF grids that are set up for each atom in the MD portion of the simulation. In FIG. 5D, several MD steps are undertaken on the portion of the system being simulated by the MD module, ignoring the presence of the Monte Carlo simulated solvent molecules, but using the PNF grid to calculate forces on the solute from the solvent by interpolating the forces pre-calculated at the PNF grid points. This process results in an altered configuration for the MD simulated molecules, as shown in FIG. 5E. Following the MD simulation, another round of MC is performed on the solvent molecules, returning the system to the state in FIG. 5B.

This process of repeatedly alternating between the simulation modules using the PNF module to mediate the interactions, is continued until a desired condition is met for the given environment and simulation ensemble. The termination conditions for a simulation are ultimately dependent upon the goals of the modeling experiment, whether it is energy minimization or the generation of a stable configuration, or the passing of a given amount of simulated time.

An important consideration for the event loop, in coordinating the Monte Carlo and molecular dynamics modules, is that these modules should be run in the same ensemble as discussed previously. Thus, if the molecular dynamics simulation is run in NPT (constant number of atoms, constant pressure, constant temperature), the Monte Carlo simulation should also be run in the NPT ensemble. This applies to other ensembles such as NVT (constant number of molecules, constant volume, constant temperature).

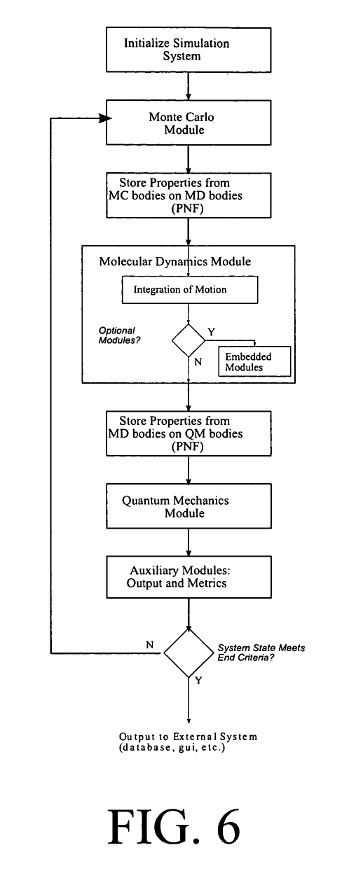

Not included in the above description are the “auxiliary function” modules (FIG. 6), which include any process that is not required for the simulation itself, but may be of interest to the user of the simulation. These functions, which typically exist in the form of independent, optional modules, may be included in the process described above at any point, depending upon the desired output from the function. This positioning, as in FIG. 6 is somewhat arbitrary, as they can be moved to any other point in the loop and even may even exist multiple times in the loop. These functions can be used as a break point to perform any form of maintenance on the system, or to provide system output, such as saving restart files, calculating metrics, exporting information to a database or saving snapshots. In general, the simulation will run faster if auxiliary functions are not called on every pass through the loop described in FIG. 6.

### Event Loop De-initialization

Once the Event Loop Module has completed the requested number of loops, the simulation is concluded, and it is assumed that the device has completed its task. Thus, the device terminates its operation by cleaning up its use of the hardware. For each Module initialized in the event loop initialization, a corresponding shut down routine is called to return the resources it was occupying back to general use.

### Monte Carlo Module

Monte Carlo algorithms are methods used to sample a probability distribution of the states in a system, which can then be statistically treated to determine the average system properties. Convergence of the system properties to the average is achieved by obtaining a sufficient number of samples from the probability distribution.

In molecular simulations, Monte Carlo algorithms attempt random changes to the positions of the particles, creating configurations that correctly sample the states of the system. Each configuration that is generated by the Monte Carlo algorithm is valid for the system being studied, however, it is only by evaluating the set of generated configurations that the properties of the system can be discovered. Any Monte Carlo module can be used in this invention, and both the Metropolis³² and Force-Biased^{33,34} Monte Carlo methods have successfully been used. One may also use preferential or importance sampling techniques, where the MC molecules near the MD molecule(s) are moved more frequently than those farther away³⁵.

Preferably the Monte Carlo modules are self-sufficient and independent, and do not keep track of how many passes through the full set of molecules have been performed. Monitoring the number of MC steps that need to be performed is preferably left to the event loop module, as described above. One MC step is defined as an attempted move on each molecule in the collection.

Full instructions on the construction of a Monte Carlo engine may be found elsewhere³⁶.

### Molecular Dynamics Module

Molecular dynamics algorithms are deterministic methods that propagate motion in time according to a set of equations. In molecular simulations, the force field governs the interactions between atoms through the various interaction types; bonds, angles, charges, etc.

The molecular dynamics (MD) algorithms function by calculating the forces on each particle in the simulation, determining how that affects the current velocity of the particle, and then performing the calculation to figure out where the new velocity would put the particle after a given length of time. These actions are together considered a single molecular dynamics step.

The level of detail used in the molecular dynamics module may be selected by the user. This can be done by selecting the potentials or force field types used by the simulation. These can be relatively simple, such as a coarse-grained or empirical based force field, in which greater speed is obtained by sacrificing some level of accuracy. At the other end of the spectrum, ab initio or semi-empirical force fields, based on quantum theory that form the basics of quantum mechanical simulations, can also be used. Any one of these methods can be used as the basis for a molecular dynamics simulation, and more than one of them may be used on a single system; i.e. using quantum mechanical based simulations to obtain a high level of accuracy for a subset of the particles in the simulation, without paying as significant a price for the remainder of the system, which is modeled using an empirical force field.

Complete instructions on how to build an MD simulation module, and what is required to initialize it can be found elsewhere³⁷.

### Potential Net Force Module

The Potential Net Force Module acts as a mediation device for the interaction between the molecules simulated by the molecular dynamics, and those simulated by the Monte Carlo portions of the system. By using the Potential Net Force Module, the user of the device is simultaneously able to maintain the accuracy equivalent to that obtained through the use of explicit solvent simulations, as well as realize an enhanced sampling with a reduction in the execution time compared to conventional Molecular Dynamics.

Unlike other mixed molecular dynamics and Monte Carlo simulations, the Potential of Net Force prevents the molecular dynamics portion of the code from being required to perform the full pair-wise calculation of the effects of the collection of MC molecules on each of the particles in the collection of MD molecules at every step in the molecular dynamics calculation and reduces the amount of time spent calculating interactions between molecules assigned to the MC simulation. Instead, the forces from the collection of MC molecules exerted on the collection of MD molecules are stored in a grid around each atom, which allows the molecular dynamics simulation to perform an interpolation operation to provide an accurate assessment of those forces. A similar technique is the Particle-In-Cell technique³⁸, in which, for example, in fluid dynamics, the simulated space is broken into cells for the calculation of pressure gradients, to assist in determining the flow of particles using the cells, as opposed to the particles. In this example, other properties would continue to be calculated in a pair-wise manner. Here, we have adapted this method to use non-bonded forces from solvent molecules, to be applied to single particles, to work over an extended series of time-steps, and to work with dynamic fields. This effectively allows the simulations of the motions of the solute portion of the system, simulated through molecular dynamics, to be separated from the solvent portion of the system, simulated by Monte Carlo. The longer the forces acting on the solute are valid, and do not need to be re-calculated from the positions of the solvent molecules, the greater the performance gain will be. This is a consequence of the decreasing number of moves required by the solvent to sample configurational space using a Monte Carlo algorithm and, therefore, the decreasing number of times that each water molecule needs to be moved by the simulation.

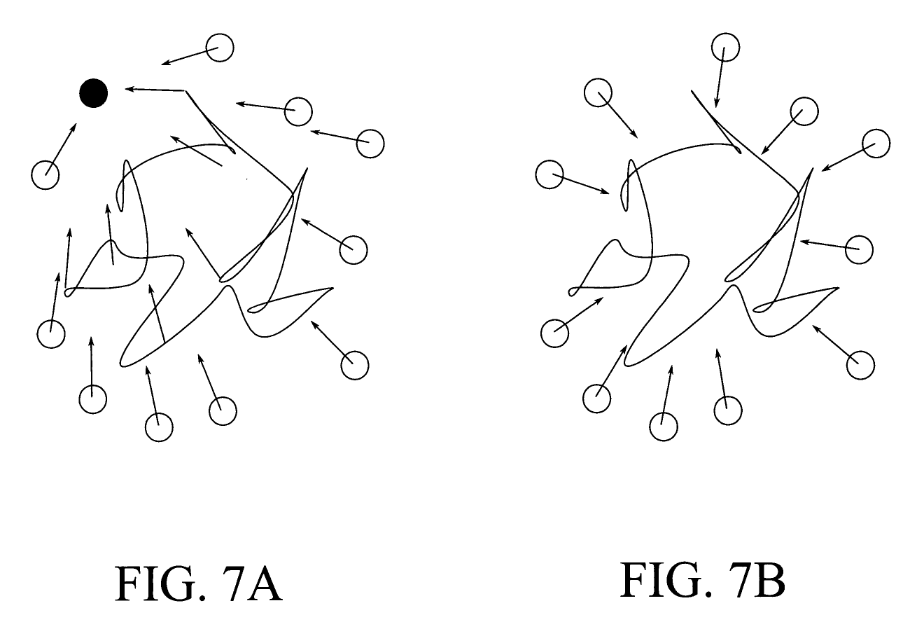

In FIG. 7B, the forces, represented by arrows, from all of the molecules simulated using the Monte Carlo method affect the molecule simulated by molecular dynamics, represented by the rounded polygon. These forces, however, are translated through the Potential Net Force module to reduce computational time.

### Force Field Module

As a part of every simulation, there are an underlying set of rules that determine the interactions between particles. For molecular modeling applications, this exists in two forms; the equations that govern the interactions and the constants that are used by the equations to describe the properties of the bodies in the simulations.

The equations governing the interactions can be broken into two types of forces; those which exist between particles that are bound within the same molecule (intramolecular), and those which exist between particles of different molecules (intermolecular). A simplified equation for the forces on a given particle can be summed as:

Fₜₒₜₐₗ=F_{intramolecular}□F_{intermolecular}

Depending on the application of the PNF method, the forces that are collected in the PNF grids can be any set of the intermolecular forces, or other forces included in the force field used, that act between bodies simulated in separate collections.

Because of the different types of force field equation and parameter sets that are available, the force field module is set up to use any one of the force fields that exist. Examples of empirical force fields include the AMBER force fields^{39,40,41}, the CHARMm force fields^{42,43}, the MM series of force fields^{44,45,46}, and OPLS⁴⁷.

### Potential Net Force Configuration

The PNF may be customized using parameters supplied by the user of the device. These can include the number and distribution of PNF points being used, the method for collecting the information for the PNF, the method for interpolating between PNF points, and the rules for determining when (the frequency) of the force values stored in the PNF are to be regenerated.

The number and distribution of the PNF points may be specified so as to require as few as possible, trading accuracy for speed. However, if some information is known about the atom for which the PNF is being generated, then it is possible to reduce the number of points without sacrificing accuracy. For instance, if the direction of movement is known for the atom for which the PNF is being generated, then it is possible to create a PNF that encompasses only the areas through which the atom is likely to pass, rather than those it would have passed through in previous time steps. Regardless of the number of points chosen, the PNF is a three-dimensional geometric arrangement of points surrounding each atom for which the PNF is being generated. The number of points and, their separation may be specified at run time.

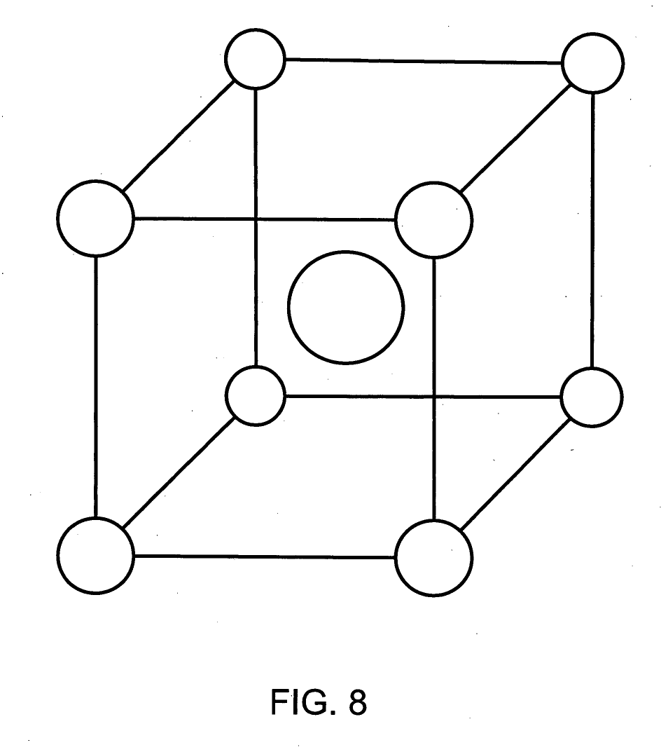

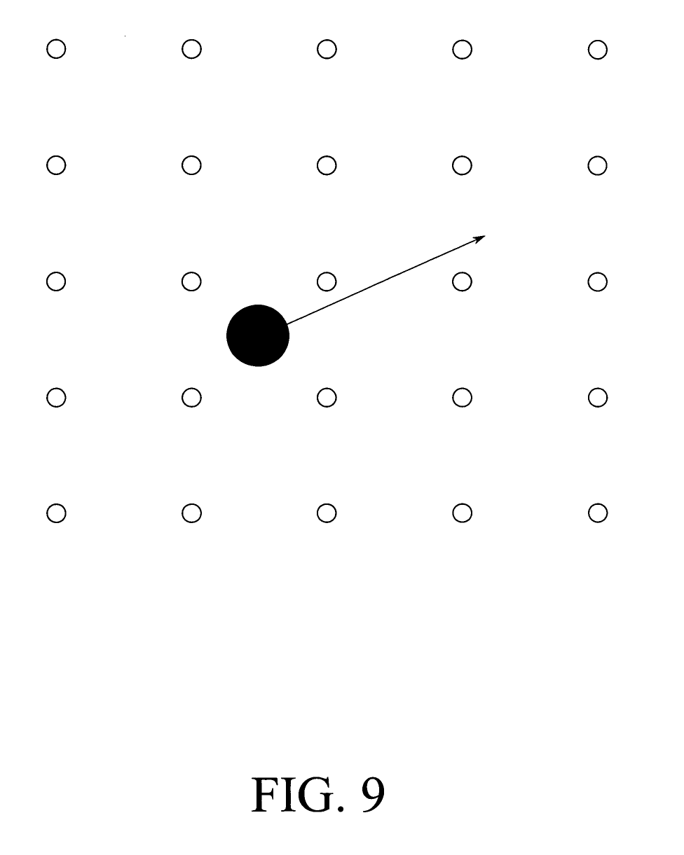

The distribution of the geometrically positioned points of the PNF around each atom for which the PNF is being generated can also be decided by the user, based on the number of points desired. For six points, an octahedral can be used. For eight points a cubic placement centred on the position of the atom, as illustrated in FIG. 8 can be used. In this figure, the large sphere represents the atom of interest, while the eight smaller spheres represent the points on the PNF grid. As the position of the atom of interest moves, a combination of the eight PNF points can be used to interpolate the forces at the current position of the atom. If desired, a greater number of points can also be used, such that if the atom leaves the area formed within the volume of the shape chosen, another PNF grid can be prepared ahead of time. In the case of a cube, this could be done either by placing the first cube within the second, larger, cube, or by creating additional cubes of the same size that share faces with the first. Another version can include preparing the grid points ahead of time, such that a mesh of grid points is created. This is represented in two-dimensions in FIG. 9, where the particle is represented by the large gray circle, and the grid points are represented by the smaller circles. In this case, only the grid points closest to the particle need to be calculated initially. As the particle travels along its path, illustrated by the arrow, the values at further grid points are calculated as well. The use of this mesh is of particular use if the particle is oscillating back and forth in its trajectory, rather than simply moving in one direction, which allows previously calculated grid points to be re-used.

Uneven distributions of the PNF grid may also be used, depending on the application. For instance, if the velocity of a particle is known to be increasing on a given trajectory (i.e, a comet traveling through a solar system) and the likelihood of a collision is small, it may be useful to create a series of PNF grids in which the body is likely to spend an equal number of steps in each grid.

Another consideration for the use of the PNF is the method of interpolation used to determine the force at a point between PNF grid points. Linear interpolation provides a method of solving this problem when the PNF grid points are spaced sufficiently close. Thus, it is important to determine the level of accuracy required, and therefore, how small the intervals should be between the placement of the grid points. This is also important in areas where the simulated system may experience significant modulations in the forces over short distances. Interpolations other than the linear method are also possible, however, the more complex the interpolation method, the more expensive the calculations become, reducing the performance of the device.

### Frequency of Potential Net Force updates

The least complex method of determining the frequency at which the PNF needs to be updated is to set a length of time for which a generated PNF may be used. This can be translated into a number of MD time-steps, in which the length of time for each step is known. Thus, the event loop coordinates the sequence of events such that after a pre-defined number of MD steps, the PNF module is run, such that the desired number of Monte Carlo steps or moves are made and the information for each of the grid points of the PNF is re-acquired.

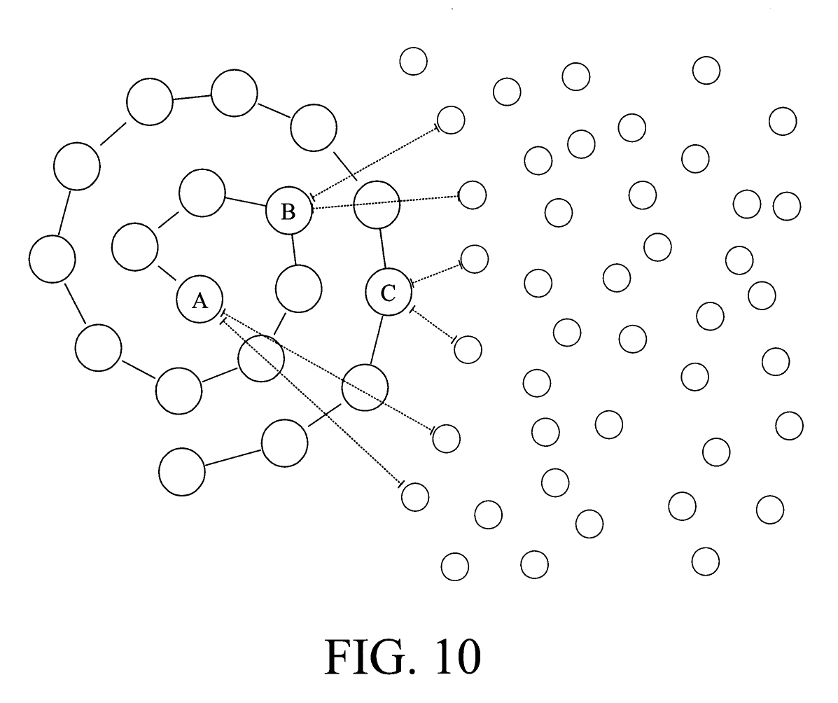

More complex methods can also be used to determine when the force at each of the PNF grid points needs to be re-acquired. These can include positional updates, where atoms in close proximity to the MC molecules are updated more frequently, and more distant from the MC molecules are not updated as frequently. This is demonstrated in the two-dimensional case in FIG. 10. In this illustration, the body marked as “A” is furthest from the MC molecules, represented by the small circles, and is less likely to be affected by the forces exerted on it by the MC molecules. The bodies in between itself and the MC bodies shield it from direct contact, and mitigate their effect on body “A”. A similar situation exists for the body “B”, although there is a reduced shielding effect. Body “C” is not shielded, and thus is affected more by the shifting positions of the MC bodies around it. Thus, the forces affecting bodies “A”, “B” and “C” are likely to change with different frequencies. Selecting methods in which the PNF grids around atoms are refreshed at different frequencies allows for less time to be spent on calculating PNF forces, and more to be spent on using the PNF in the MD calculation, improving the performance of the device.

### Potential Net Force Generation

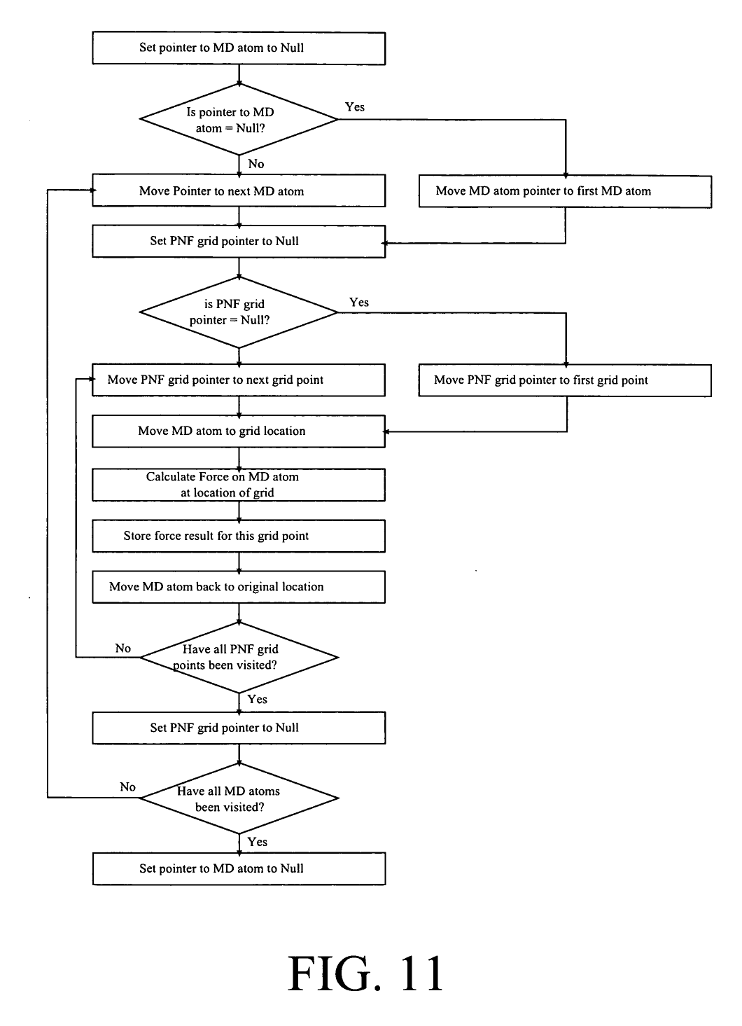

The process to update or generate the PNF grid is shown in FIG. 11, but can be summed up in pseudo code.

For (each solute atom in the simulation) {
For (each grid point for that atom) {
   Move atom to a point on the grid
   Calculate forces from all solvent atoms on the solute atom
   Store forces acting at that point
}
Move atom back to its original location

{This process iterates over each atom in each molecule in the MD module, and moves each to the points on it's PNF grid, where the calculations of force are performed, and the results of those calculations are stored. Each atom is returned to its original location once it has been moved to each of it's PNF grid points.

### Applying a Potential Net Force in a Molecular Dynamics Simulation

The Potential Net Force is easily applied during a Molecular Dynamics simulation. In an MD simulation without a PNF, using the chosen force field, inter- and intra-molecular forces can be used to calculate the accelerations and velocities. In the case of the PNF, the significant difference is observed in the intermolecular interactions. Instead of performing the pair wise interactions between the solute and all solvent molecules during the force calculation, the solvent molecules themselves are ignored, and the force stored in the PNF grids are used instead to interpolate the forces affecting the atoms of the solute.

### Other Modules

The present method disclosed herein may include various computational techniques, which are currently available and can be used for various calculations at different stages in the simulations. These techniques are embodied in various computational modules currently available. Thus, the method disclosed herein is compatible with other modules commonly used in the field of molecular computer simulations, including all of the standard Molecular Dynamics or Monte Carlo simulation modules. This list includes, but is not limited to:

1) Group Based Cutoff Modules⁴⁸ provide techniques for reducing the number of pairwise distances that are calculated during the course of a simulation and, therefore, reduce the computational time required for execution;

2) Long Range Correction Modules^{49,50,51} provide techniques that are used to correct the electrostatic energy and force due to the use of a finite system size;

3) Neighbor List Modules^{52,53} and Binning Modules (see copending patent application Ser. No. 11/441,526 which is incorporated herein by reference in its entirety) provide techniques that may be used to identify the particles in the system that must be included in the calculation of the energy and force on a given particle, however it will be understood that this can be achieved using a different algorithm other than binning, such as a neighbor list.

4) System Restarts Modules used to report the information necessary to restart a simulation, which consists of the Cartesian coordinates of the particles in the system and, in the case of molecular dynamics simulations, the velocities of each particle in the system;

5) Constraint Modules^{54,55,56} provide techniques that are used to specify conditions that must be satisfied during the course of a simulation, such as fixed bond lengths or angles;

6) Thermostat Modules^{57,58,59,60} provide techniques used to maintain constant temperature during the course of a simulation;

7) Barostat Modules^{61,62,63} provide techniques used to maintain constant pressure during the course of a simulation; and

8) Metrics and Output Modules provide techniques used to report Cartesian coordinates of some or all of the particles in the system and measurements of the system properties, such as energy, temperature, and pressure, during the course of a simulation.

It will be understood by those skilled in the art that the present system and method disclosed herein and embodied in the claims is not restricted per se to being implemented by only the computational modules disclosed herein.

### Complex Simulations

The hybrid MC/MD method may be applied to complex systems, in which the simulated system is composed from different compounds of varying sizes. The outlined method deals specifically with the interactions of solute and solvent particles, but it can be extended to handle additional cases. In particular, the solvent can be comprised of mixtures of different molecules, with the most common example being mixtures of water and an alcohol, such as methanol or ethanol. Additionally, simulations with multiple types of solute molecules can be performed with this method. When the trajectory of a molecule is of interest, it is simulated by molecular dynamics, whereas all other molecules should be simulated by Monte Carlo.

### Docking

One application for this device is in the docking of molecules, a key problem in the pharmaceutical industry and in the development of industrial biocatalysts. Docking is the attempt to find the best fit, as determined by the lowest possible energy conformation, between one molecule and a large biomolecule, such as a protein. Docking often involves fitting a small organic molecule into a cavity or indentation in the surface of the biomolecule, whereby a stable interaction is formed and the energy is often drastically lower than when the two molecules are separated by some distance or in any alternate configuration.

In this application, the large biomolecule is included in the molecular dynamics collection and the solvent molecules are included in the Monte Carlo collection. The other organic molecule that is to be docked can be included in either the molecular dynamics or the Monte Carlo collection. If included in the molecular dynamics collection, then the trajectory of the molecule can be determined. This is important if one wants to understand how long the organic molecule will reside in the binding site of the biomolecule. Effectively, this is a measure of the stability of the interaction between the organic molecule and the biomolecule. Different information can be obtained if the organic molecule is included in the Monte Carlo collection. Since Monte Carlo algorithms are efficient at sampling conformational states of a system, this would be useful to determine the conformations that the organic molecule will have when bound to the biomolecule. Regardless of which collection the organic molecule is included, the relevant properties to calculate in this application are the interaction energies of the organic molecule with the biomolecule and with the solvent.

There is one additional module which may be necessary when performing simulations with an organic molecule docked into a solvated biomolecule. The user may want to restrain the organic molecule to the docking site so that the interactions between the organic molecule and the biomolecule can be investigated. This is particularly important if the organic molecule tends to diffuse away from the docking site on the biomolecule. This feature is handled using a restraints module. A “restraints” module involves applying an additional potential energy and force to the biomolecule and the organic molecule that keeps them within a certain distance from one another.

The application of the present method provides several advantages over current docking applications. Many docking applications scale the interaction between solvents and solutes. The PNF provides a natural means of performing this function, as the interactions between solvents and solutes are already separated⁶⁴. This also enables alternate forms of scaling, such as the scaling of distances between solvents and solutes.

Another advantage of the PNF relevant to docking is the improved sampling of solvent configurations. Since most applications employ an implicit solvent approach, this present method is useful when implicit salvation provides too poor a resolution to generate accurate docking results. Finally, the inclusion of the biomolecule in the MD collection results in a flexible structure due to the nature of the algorithm, while most current docking algorithms model the biomolecule as a static molecule that does not undergo any changes in its atomic coordinates.

### Rational Design of Enzymes

Another application of the method disclosed herein is to the rational design of enzymes. Enzymes are proteins that catalyze chemical reactions by binding the reactant, or substrate, performing the chemical transformation, and then releasing the products from the enzyme binding site. After the product is released, the enzyme is available to perform the same reaction on another substrate molecule. In general, an enzyme is highly specific and only catalyzes reactions with a limited number of substrate types. Rational design of enzymes is the process by which the amino acid sequence of the enzyme is modified to either increase the rate at which the chemical reaction occurs or to change the types of substrates for which it catalyzes a reaction.

The method described herein can be used to perform the rational design of enzymes by simulating the chemical reaction that converts the substrate to a product. From that simulation, modifications to the amino acid sequence of the enzyme can be made that achieve the intended goal of the design. In this embodiment, the enzyme and substrate are included in the molecular dynamics collection, while the solvent molecules are included in the Monte Carlo collection. However, since classical simulations are not suited for simulations where covalent bonds are broken and formed, some or all of the atoms and molecules need to be simulated using quantum mechanical techniques. This is an example where the MD collection of particles has sub-collections that are treated at different levels of theory. One sub-collection is simulated using classical techniques, while the other sub-collection is simulated using quantum mechanical methods. In general, the quantum mechanical sub-collection corresponds to those atoms or molecules undergoing covalent bond breaking and forming, while the remainder of the molecular dynamics collection is assigned to the sub-collection that is propagated via classical mechanics.

### Simulating Membranes

Membrane systems are a special case of a complex simulation. In addition to the solute and solvent systems that are discussed, the membrane molecules are an intermediate size, and can thus be simulated by either Molecular Dynamics or by Monte Carlo. However, unlike the small solvent molecules, they have a greater number of internal degrees of freedom, and thus require more complex Monte Carlo algorithms, such as configurational bias, to be used. Depending on the ultimate goal of the simulation, the choice of which simulation method is to be applied to the intermediate molecules, or membrane lipids, may be left to the user to decide. As with the other embodiments, the solvent molecules are simulated using Monte Carlo.

### Alternate forms of a Potential Net Force

The Potential Net Force, referred to throughout this application as PNF, is simply a mechanism for translating the forces acting upon the molecules of one collection of particles from the molecules of the other collection of particles. It is designed to replace the potentials used by implicit solvation models, although it may be applied to non-molecular systems.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFENENCES

1 MacKerell A D Jr, Bashford D, Bellott M, Dunbrack R L Jr, Evanseck J D, Field M J, Fischer S, Gao J, Guo H, Ha S, Joseph-McCarthy D, Kuchnir L, Kuczera K, Lau F T K, Mattos C, Michnick S, Ngo T, Nguyen D T, Prodhom B, Reiher W E III, Roux B, Schlenkrich M, Smith J C, Stote R, Straub J, Waranabe M, Wiórkiewicz-Kuczera J, Yin D, and Karplus M. All-Atom Empirical Potential for Molecular Modeling and Dynamics Studies of Proteins, J. Phys. Chem. B, 102 (18), 3586-3616, (1998)

2 Sadlej J, Semi-empiical methods of quantum chemistry. Halstead Press, new York (1985)

3 Lawley K P (ed), Ab Initio methods in quantum chemistry Parts I and II. Wiley, Chichester (1987)

4 Haliloglu T, Coarse-Grained Simulations of Conformational Dynamics of Proteins, Theoretical and Computational Polymer Science, 9/3-4, 255-260 (1999)

5 Car R and Parrinello M. Unified Approach for Molecular Dynamics and Density-Functional Theory, Phys. Rev. Lett. 55, 2471-2474 (1985)

6 Laio A, VandeVondele J, Rothlisberger U. A Hamiltonian electrostatic coupling scheme for hybrid Car-Parinello molecular dynamics simulations. Journal of Chemical Physics, 116(16):6941-6947 (2002)

7 Tobias D J and Brooks C L, Molecular Dynamics with Internal Coordinate Constraints, Journal of Chemical Physics, 89: 5115-5126 (1988)

8 Weiner S J, Kollman P A, Case D A, Singh C, Ghio C, Alagona G, Profeta S Jr., Weiner, P, A New Force Field for Molecular Mechanical Simulation of Nucleic Acids and Proteins, J. Am. Chem. Soc., 106: 765-784 (19984)

9 Warwicker J and Watson H C, Calculation of the Electric Potential in the Active-Site Cleft Due to Alpha-Helix Dipoles, Journal of Molecular Biology, 157: 671-679 (1982)

10 Still W C, Tempczyrk A, Hawley R C, Hendrickson T, Semianalytical Treatment of Solvation for Molecular Mechanics and Dynamics, Journal of the American Chemical Society, 112: 6127-6129 (1990)

11 Hut P and Makino J, Astrophysics on the GRAPE family of special-purpose computers, Science, 283(5401): 501-5 (1999)

12 Buehler M J, Hartmaier A, Gao H, Abraham F F, Atomic plasticity: description and analysis of a one-billion atom simulation of ductile materials failure, Comput. Methods Appl. Mech. Engrg., 193:5257-5282 (2004)

13 Levitt M and Sharon R, Accurate Simulation of Protein Dynamics in Solution, Proc. Natl. Acad. Sci. USA. 85: 7557-7561 (1988)

14 Pearlman D A, Case D A, Caldwell J W, Ross W S, Cheatham T E III, Debolt S, Ferguson D, Seibel G, and Kollman P, AMBER, a Package of Computer Programs for Applying Molecular Mechanics, Normal Mode Analysis, Molecular Dynamics and Free Energy Calculations to Simulate the Structural and Energetic Properties of Molecules, Comp. Phys. Commun., 91: 1-41 (1995)

15 Brooks B R, Bruccoleri R E, Olafson B D, States D J, Swaminathan W, Karplus M, CHARMM: A Program for Macromolecular Energy, Minimization, and Dynamics Calculations, J. Comput. Chem., 4, 187-217 (1983)

16 Kalé L, Skeel R, Bhandarkar M, Brunner R, Gursoy A, Krawetz N, Phillips J, Shinozaki A, Varadarajan K, Schulten K, NAMD2: Greater Scalability for Parallel Molecular Dynamics, J. Comput. Phys., 151: 283-312 (1999)

17 Berendsen H J C, van der Spoel D, van Drunnen R, GROMACS: A Message-passing Parallel Molecular Dynamics Implementation, Comp. Phys. Commun., 91: 43-56 (1995)

18 Scott W R P, Hunenburger P H, Tironi I G, Mark A E, Billeter S R, Fennen J, Kruger A, van Gunsteren W F, The GROMOS Biomolecular Simulation Program Package, J. Phys. Chem. A, 103: 3596-3607 (1999)

19 Still W C, Tempczyk A, Hawley R C and Hendrickson T. Semi-analytical treatment of solvation for molecular mechanics and dynamics. J. Am. Chem. Soc. 1990, 112, 6127-9

20 Qui D, shenkin P S, Hollingger F P, Still W C, The GB/SA Continuum Model for Solvation. A Fast Analytical Method for the Calculation of Approximate Born Radii. Journal of Physical Cemistry 101:3005-3014 (1997)

21 Chorny I, Dill K A, Jacobson M P, Surfaces Affect Ion Paring, J. Phys. Chem. B, 109(50); 24056-24060, (2005)

22 Jaramillo, A. and Wodak, S. Computational Protein Design is a nge for Implicit Solvation Models. Biophysical Journal, 88, 156-171 (200)

23 Lee M S, Salsbury F R Jr., Olson M A, An Efficient Hybrid Explicit/Implicit Solvent Method for Biomolecular Simulations, J. Comput. Chem. 25: 1967-1978 (2004)

24 Leach, Molecular Modeling: Principles and Applications, 2nd Ed. Addison Wesley Longman, Essex, England, (2001), section 4.9.11

25 Alder B J and Wainwright T E, Phase transition for a hard sphere system. J. Chem. Phys., 27 (1957)

26 Leach A R, Molecular Modeling: Principles and Applications, 2nd Ed. Addison Wesley Longman, Essex, England, (2001)

27 Pangali C, Rao M, Berne B J, On a Novel Monte Carlo Scheme for Simulating Water and Aqueous Solutions, Chemical Physics Letters, 55: 413-417 (1978)

28 Rao M and Berne B J, On the Force Bias Monte Carlo Simulation of Simple Liquids, Journal of Chemical Physics, 71: 129-132 (1979)

29 Leach, Molecular Modeling: Principles and Applications, 2nd Ed. Addison Wesley Longman, Essex, England, (2001), Ch. 5.

30 Allen M P and Tildesley D J, Computer Simulation of Liquids, Oxford University Press, Oxford, Section 1.5 (1987)

31 Leach A R, Molecular Modeling: Principles and Applications, 2nd Ed. Addison Wesley Longman, Essex, England, (2001), Ch 2,3,7 and 8

32 Metropolis N, Rosenbluth A W, Rosenbluth M N. Teller A H and Teller E, Equation of State Calculations by Fast Computing Machines, J. Chem. Phys. 21:1087-1092. (1953)

33 Pangali C, Rao M, Berne BJ, On a Novel Monte Carlo Scheme for Simulating Water and Aqueous Solutions, Chemical Physics Letters, 55: 413-417 (1978)

34 Rao M and Berne B J, On the Force Bias Monte Carlo Simulation of Simple Liquids, Journal of Chemical Physics 71: 129-132 (1979)

35 Owicki J. and Scheraga HA, Preferential sampling near solutes in Carlo calculations on dilute solutions, Chem Phys Lett, 47:600-602 (1977)

36 Leach A R, Molecular Modeling: Principles and Applications, 2nd Ed. n Wesley Longman, Essex, England, (2001), Ch. 8

37 Leach A R, Molecular Modeling: Principles and Applications, 2nd Ed. Addison Wesley Longman, Essex, England, (2001), Ch. 7

38 Harlow F H, The particle-in-cell computing methods for fluid dynamics, Methods Comput. Phys. 3, 319-343 (1964)

39 Weiner S J, Kollman P A, Case D A, Singh C, Ghio C, Alagona G, Profeta S Jr., Weiner, P, A New Force Field for Molecular Mechanical Simulation of Nucleic Acids and Proteins, J.Am. Chem. Soc., 106: 765-784 (1984)

40 Cornell W D, Cieplak P, Bayly C I, Gould I R, Merz K M, Jr., Ferguson D M, Spellmeyer D C, Fox T, Caldwell J W, and Kollman P A, A second gerneration force field for the simulation of proteins, nucleic acids, and organic molecules. J. Am. Chem. Soc. 117, 5179-5197 (1995)

41 Wang J, Wolf R M, Kollman P A, Case D A, Development and Testing of a General Amber Force Field, Journal of Computational Chemistry, 25(9): 1157-1174 (2004)

42 MacKerell A D, Empirical Force Fields for Biological Macromolecules: Overview and Issues, Journal of Computational Chemistry, 25: 1584-1604, (2004)

43 Foloppe N and MacKerell AD, All-Atom Empirical Force Field for Nucleic Acids: 1) Parameter Optimization Based on Small Molecule and Condensed Phase Macromolecular Target Data. Journal of Computational Chemistry, 21:86-104 (2000)

44 Allinger, N L. Conformational Analysis 130. MM2. A Hydrocarbon Force Field Utilizing V1 and V2 Torsional Terms, J. Am. Chem. Soc. 99, 8127-8134 (1977)

45 Allinger, N L., Yuh, Y H and Lii, J-H. Molecular Mechanics. The MM3 Force Field for Hydrocarbons. 1. J. Am. Chem. Soc. 111, 8551-8565 (1989)

46 Allinger, N L., Chen K, and Lii J-H, An Improved Force Field (MM4) for Saturated Hydrocarbons, J. Comp. Chem. 17, 642-668 (1996)

47 Kaminski G A, Friesner R A, Tirado-Rives J, Jorgensen W L, Evaluation and Reparametrization of the OPLS-AA Force Field for Proteins via Comparison with Accurate Quantum Chemical Calculations on Peptides, J. Phys. Chem. B 105 6474-6487 (2001)

48 Leach A R, Molecular Modeling: Principles and Applications, 2nd Ed. Addison Wesley Longman, Essex, England, (2001), Ch. 6

49 Ewald P P, Due Berechnung optishcer und elektrostatischer Gitterpotentiale. Annalen der Physik 64:253-287 (1921)

50 Leach A R, Molecular Modeling: Principles and Applications, 2nd Ed. Addison Wesley Longman, Essex, England, (2001), Section 6.8.2.

51 Essmann U, Perera L, Berkowitz M L, Darden T, Lee H and Pedersen L G, A smooth particle mesh Ewald method. J. Chem. Phys., 103, 8577 (1995)

52 Verlet L, Computer ‘Experiments’ on Classical Fluids. II. Equilibrium Correlation Functions, Physical Review, 165: 201-204 (1967)

53 Thompson S, Use of Neighbour Lists in Molecular Dynamics. CCP5 Quarterly, 8: 20-28 (1983)

54 Ryckaert J P, Cicotti G, Berendsen H J C, Numerical Integration of the Cartisian Equations of Motion of a System with Constraints: Molecular Dynamics of n-Alkanes, Journal of Computational Physics 23:327-341 (1977)

55 Anderson H C, A ‘Velocity’ Version of the SHAKE Algorithm for Molecular Dynamics Calculations, Journal of Computational Physics 54: 24-34 (1983)

56 Miyamoto S and Kollman P A, Settle: An analytical version of the SHAKE and RATTLE algorithm for rigid water models, Journal of Computational Chemistry, 13(8); 952-962 (1992)

57 Berendsen H J C, Postma J P M, van Gunsteren W F, DiNola A and Haak J R, Molecular dynamics with coupling to an external bath, The Journal of Chemical Physics, 81(8):3684-3690 (1984)

58 Nosé S, A Molecular Dynamics Method for Simulations in the Cannonical Ensemble, Molecular Physics 53:255-268 (1984)

59 Hoover W G, Canonical Dynamics: Equilibrium Phase-space Distributions. Physical Review A31: 1695-1697 (1985)

60 Grest G S, Kremmer K, Molecular dynamics simulation for polymers in the presence of a heat bath. Phys. Rev. A 33(5):3628-3631 (1986)

61 Andersen H C, Molecular dynamics simulations at constant pressure and/or temperature. J. Chem. Phys. 72:2384-2393 (1980)

62 Nose S, A unified formulation of the constant temperature molecular dynamics methods, J. Chem. Phys. 81:511-519 (1984)

63 Hoover W G, Canonical dynamics: Equilibrium phase-space distributions, Physical Review A. 31(3):1695-1697 (1985)

64 Friesner R A, Bandks J L, Murphy R B, Halgren T A, Klicic J J, Mainz D T, Repasky M P, Knoll E H, Shaw D E, Shelley M, Perry J K, Francis P, Glide: A New Approach for Rapid, Accurate Docking and Scoring. 1. Method and Assessment of Docking Accuracy, J. Med. Chem., 47:1739-1749 (2004)

Therefore what is claimed is:

1. A method for simulating the behavior of a system formed by a plurality of particles using at least two different simulation techniques, comprising the steps of:
a) forming a first collection of particles from some of said plurality of particles, and forming at least a second collection of particles from a remainder of said plurality of particles;
b) simulating behavior of the particles in said first collection of particles using a first simulation technique;
c) repeating step b) a first pre-selected number of times;
d) obtaining and storing information about said particles in said first collection of particles, characteristic of said first simulation technique, from steps b) and c);
e) simulating behavior of the particles in said second collection of particles using at least a second simulation technique using said information obtained and stored in step d);
f) repeating step e) a second pre-selected number of times; and
g) repeating steps b) to f) inclusive a user determined number of times until the user has observed a time evolution of the system from which useful information can be extracted.

2. The method according to claim 1 wherein said particles making up said system include atoms, inorganic molecules, organic molecules, biomolecules, and any combination thereof.

3. The method according to claim 2 wherein all of said simulation techniques are run in the same ensemble.

4. The method according to claim 3 wherein said ensemble is an ensemble selected from the group consisting of pVT, NVT, NVE, NPT and NPH, where N is a number of atoms, p is the chemical potential, T is the temperature, P is the pressure, V is the volume of the simulation space, H is the enthalpy of the system, and E is the energy of the system.

5. The method according to claim 3 wherein said first pre-selected number of times is a number of times required until desired properties of the particles in said first collection of particles are observed, and wherein step f) is repeated at intervals that allow a user determined level of sampling to be obtained.

6. The method according to claim 3 wherein upon completion of step f) and prior to step g), including reassigning some or all particles in the first collection to the second collection and reassigning some or all the particles in the second collection to the first collection.

7. The system according to claim 3 wherein said step d) of obtaining and storing information from steps b) and c) includes calculating the energy and force for the particles within the first collection and storing said calculated energy and force information, and wherein in step e) said information stored in step d) is transferred to said second collection of particles and used in simulating the behavior of the particles in said second collection of particles.

8. The method according to claim 3 wherein said useful information includes conformation properties of biomolecules, time-dependent behaviour of single molecules, time-dependent behaviour of groups of molecules, means and mechanisms of interactions and chemical reactions between molecules.

9. The method according to claim 3 wherein said at least two simulation techniques are any one of Monte Carlo simulation, molecular dynamics simulation or combinations thereof.

10. The method according to claim 3 wherein said first simulation technique is a Monte Carlo simulation, and said second simulation technique is a molecular dynamics simulation.

11. The method according to claim 10 wherein the second simulation technique is either a classical or quantum mechanical molecular dynamics simulation.

12. The method according to claim 10 wherein the second simulation technique includes more than one type of molecular dynamics simulation, including classical molecular dynamics simulation, quantum mechanical molecular dynamics simulation, and combinations thereof.

13. The method according to claim 10 wherein said step d) of obtaining information characteristic of said first simulation technique from steps b) and c) includes calculating forces exerted by said particles assigned to said first collection of particles, using said Monte Carlo simulation, and storing said forces at a pre-selected number of grid points surrounding each particle in said second collection of particles, and wherein said step e) of simulating behavior of the particles in said second collection of particles includes interpolating to obtain a force experienced by each particle in said second collection of particles to obtain a net force at each particle's current position, and calculating a trajectory of each particle in said second collection of particles.

14. The method according to claim 13 wherein said pre-selected number of grid points are evenly spaced in a geometric pattern around each particle in said second collection of particles.

15. The method according to claim 13 wherein said pre-selected number of grid points are unevenly spaced in a geometric pattern around each in said second collection of particles.

16. The method in claim 15 wherein said unevenly spaced grid points are positioned around each particle in said second collection of particles in response to a predicted path of each particle in said second collection of particles.

17. The method in claim 13 where said interpolation is performed by any one of a linear interpolation, polynomial interpolation, spline interpolation and any combination thereof.

18. The method in claim 10 where said Monte Carlo simulation is a Metropolis Monte Carlo simulation.

19. The method in claim 10 where said Monte Carlo simulation is a force-biased Monte Carlo simulation.

20. The method in claim 10 where said Monte Carlo simulation is a Smart Monte Carlo simulation.

21. The method in claim 2 including a step of equilibrating the system prior to step a).

22. The method according to claim 10 wherein the step e) of simulating behavior of the particles in said second collection of particles using said molecular dynamics simulation includes calculating trajectories of the particles in the second collection of particles.

23. The method according to claim 3 wherein said first and second simulation techniques are both the same type of simulation.

24. The method according to claim 3 wherein non-equilibrium conditions are simulated.

25. The method according to claim 10 wherein said step e) of simulating behavior of the particles in said second collection of particles using at least a second simulation technique using said information obtained and stored in step d), includes simulating behavior of a subset of said particles in said second collection using a quantum mechanical simulation.

26. The method according to claim 3 wherein said first and second simulation techniques are the same technique but which use different methods of calculating forces and propagating motion.

27. The method according to claim 25 said first and second simulation techniques are molecular dynamics simulation wherein said first simulation technique is a classically derived molecular dynamics simulation, and wherein said second simulation technique is a quantum mechanical derived molecular dynamics simulation.

28. The method according to claim 13 wherein said particles assigned to said first collection of particles are solvent molecules forming a solvent, and wherein said particles assigned to said second collection of particles are solute molecules forming a solute located in said solvent, and wherein step e) includes simulating behaviour of the solute molecules in said solvent for determining interactions between the solute and the solvent.

29. The method according to claim 28 wherein said solvent molecules making up said solvent include one type of solvent molecule such that the solvent is a homogeneous solvent.

30. The method according to claim 28 wherein said solute molecules include one type of solute molecule.

31. The method according to claim 28 wherein said solvent molecules making up said solvent include one type of solvent molecule such that the solvent is a homogeneous solvent, and wherein said solute molecules include only one type of solute molecule.

32. The method according to claim 28 wherein said solvent molecules making up said solvent include two or more different types of solvent molecules such that said solvent is a heterogeneous solvent, and wherein step e) includes simulating behaviour of the solute molecules in said heterogeneous solvent.

33. The method according to claim 28 wherein said solute molecules include two or more different types of solute molecules, and wherein step e) includes simulating behaviour of the two or more different types of solute molecules in said solvent.

34. The method according to claim 28 wherein said solvent molecules making up said solvent include two or more different types of solvent molecules, and wherein said solute molecules include two or more different types of solute molecules, and wherein step e) includes simulating behaviour of the two or more different types of solute molecules in said heterogeneous solvent.

35. The method according to claim 13 wherein
i) said particles assigned to said second collection of particles simulated using said molecular dynamics simulation is at least one biomolecule having at least one binding site, and
ii) wherein said particles assigned to said first collection of particles simulated using said Monte Carlo simulation include solvent molecules forming a solvent and at least one organic molecule to be docked in said at least one binding site in said at least one biomolecule, and wherein said useful information extracted from the simulations are interaction energies of the at least one organic molecule with at least one biomolecule and with the solvent.

36. The method according to claim 35 wherein said useful information extracted from the simulations includes determining conformations that the organic molecule have when in said at least one binding site.

37. The method according to claim 35 including a step of applying sufficient potential energy and force to the at least one biomolecule and the organic molecule to keep them within a certain distance from one another for restraining the organic molecule to the at least one binding site.

38. The method according to claim 13 wherein
i) said particles assigned to said first collection of particles simulated using said Monte Carlo simulation include solvent molecules forming a solvent, and
ii) wherein said particles assigned to said second collection of particles simulated using said molecular dynamics simulation include at least one biomolecule having at least one binding site and at least one organic molecule to be docked with said at least one biomolecule in said at least one binding site, and wherein said useful information extracted from the simulations are interaction energies of the at least one organic molecule with the at least one biomolecule and with the solvent.

39. The method according to claim 38 wherein said useful information extracted from the simulations includes determining a trajectory of the organic molecule for estimating how long any one organic molecule will reside in the at least one binding site of the at least one biomolecule to give a measure of the stability of the interaction between the organic molecule and the at least one biomolecule.

40. The method according to claim 38 including a step of applying a sufficient potential energy and force to the at least one biomolecule and the organic molecule to keep them within a certain distance from one another for restraining the organic molecule to the at least one binding site.

41. The method according to claim 13 which is executed by a computer under the control of a program, said computer including a memory for storing said program, wherein said step b) of simulating behavior of the particles in said first collection of particles using said Monte Carlo simulation technique is performed using a Monte Carlo simulation computational module, and wherein step d) of obtaining and storing information about said particles in said first collection of particles, characteristic of said Monte Carlo simulation technique includes using a potential net force computational module, and wherein step e) of simulating behavior of the particles in said second collection of particles using said molecular dynamics simulation technique using said information obtained and stored in step d) includes using a molecular dynamics simulation computational module, and wherein said potential net force computational module mediates between the Monte Carlo and molecular dynamics simulation technique modules to transfer information from molecules simulated using the Monte Carlo simulation technique module to molecules simulated using the molecular dynamics simulation technique.

42. The method according to claim 41 including a Binning Module, an Energy Calculation Module, and a Force Field Module used to calculate the energies and forces required by the Monte Carlo module, the molecular dynamics module, and the potential of net force module.

43. A system under computer control for simulating the behavior of a system formed by a plurality of particles using at least two different simulation techniques, the system comprising:
a computer processor having computer storage, the computer processor being programmed for the tasks of
i) forming a first collection of particles from some of said plurality of particles, and forming at least a second collection of particles from a remainder of said plurality of particles;
ii) simulating behavior of the particles in said first collection of particles using a first simulation technique;
iii) repeating task ii) a first pre-selected number of times;
iv) obtaining and storing information about said particles in said first collection of particles, characteristic of said first simulation technique, from the results of tasks ii) and iii);
v) simulating behavior of the particles in said second collection of particles using at least a second simulation technique using said information obtained and stored during task iv);
vi) repeating task v) a second pre-selected number of times; and
vii) repeating tasks ii) to vi) inclusive a user determined number of times until the user has observed a time evolution of the system from which useful information can be extracted.

44. The system according to claim 43 wherein said particles making up said system include any one of atoms, inorganic molecules, organic molecules, biomolecules, and any combination thereof.

45. The system according to claim 44 wherein the processing means is programmed to simulate behavior of the particles in said first collection using a Monte Carlo simulation technique, and wherein the processing means is programmed to simulate behavior of the particles in said second collection using a molecular dynamics simulation technique.

46. The system according to claim 45 wherein said processing means is programmed for calculating the energy and force for atoms, molecules or any combination thereof within each collection and storing said calculated energy and force information and transferring said stored energy and force information between the two collections in tasks ii), iii), iv), v), vi) and vii).

47. The system according to claim 46 wherein said processing means programmed for calculating the energy and force is programmed for calculating forces exerted by said particles assigned to said first collection of particles, and storing said forces at a pre-selected number of grid points surrounding each particle in said second collection of particles, and wherein said processing means is programmed for using interpolation to obtain a force experienced by each particle in said second collection of particles to obtain a net force at each particle's current position, and calculating a trajectory of each particle in said second collection of particles.

48. The system according to claim 47 wherein said pre-selected number of grid points are evenly spaced in a geometric pattern around each particle in said second collection of particles.

49. The system according to claim 47 wherein said pre-selected number of grid points are unevenly spaced in a geometric pattern around each in said second collection of particles.

50. The system according to claim 49 wherein said unevenly spaced grid points are positioned around each particle in said second collection of particles in response to a predicted path of each particle in said second collection of particles.

51. The system according to claim 44 wherein the processing means is programmed to simulate behavior of the particles in said first collection using any one of a Monte Carlo simulation technique, a molecular dynamics simulation technique selected from the group consisting of classical and quantum mechanical molecular dynamics simulation techniques, and combinations thereof.
